(19) United States
(12) Patent Application Publication
(10) Pub. No.: US 2010/0271552 A1
(43) Pub. Date: Oct. 28, 2010

(54) INTELLIGENT DIGITAL PHOTO FRAME

(75) Inventors: CHUNG-JEN LAN, Tu-Cheng (TW); KUAN-HONG HSIEH, Tu-Cheng (TW); XIAO-GUANG LI, Shenzhen City (CN); MING-FENG TSAI, Tu-Cheng (TW)

Correspondence Address: Altis Law Group, Inc.;ATTN: Steven Reiss, 288 SOUTH MAYO AVENUE, CITY OF INDUSTRY, CA, 91789, US

(73) Assignees: HONG FU JIN PRECISION INDUSTRY (ShenZhen) CO., LTD., Shenzhe City (CN); HON HAI PRECISION INDUSTRY CO., LTD., Tu-Cheng (TW)

(21) Appl. No.: 12/485,048

(22) Filed: Jun. 16, 2009

(30) Foreign Application Priority Data
Apr. 28, 2009 (CN) 200920302663.3

(51) Int. Cl. H04N 5/57; H04N 5/66

(52) U.S. Cl. 348/687; 348/739; 348/E05.133; 348/E05.119

(57) ABSTRACT

A digital photo frame (DPF) includes a power management unit connected to a power source, configured for distributing power from the power source to the DPF; a display panel configured for displaying displayable media; a sound sensor configured for detecting sound waves around the DPF and generating a sound signal according to the detected sound wave; a light detector configured for detecting current ambient light level and producing a light signal corresponding to the detected ambient light level; and a processing unit configured for adjusting brightness of the display panel according to the sound signal and the light signal.

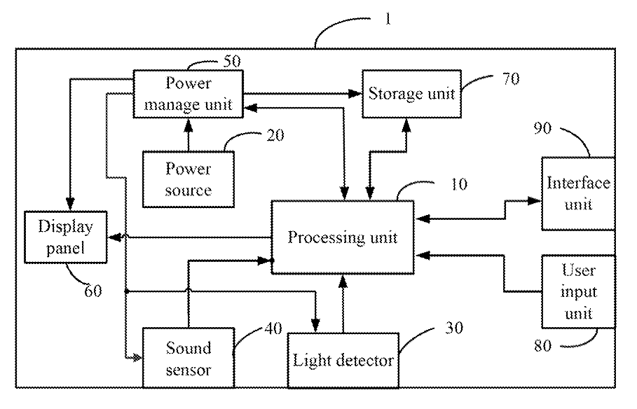

### RELATED APPLICATIONS

This application is related to copending applications entitled, “INTELLIGENT DIGITAL PHOTO FRAME”, filed **** (Atty. Docket No. US 24557); “INTELLIGENT DIGITAL PHOTO FRAME”, filed **** (Atty. Docket No. US24560); “INTELLIGENT DIGITAL PHOTO FRAME”, filed **** (Atty. Docket No. US24561); and “INTELLIGENT DIGITAL PHOTO FRAME”, filed **** (Atty. Docket No. US24562).

### BACKGROUND

1. Technical Field

The disclosure relates to electronic devices and, particularly, to a digital photo frame.

2. Description of Related Art

Nowadays, digital photos are getting more and more popular while digital cameras are becoming more and more affordable. Accordingly, in order to conveniently display digital photos, digital photo frames are invented. Unfortunately, manual adjustment of settings of the digital photo frames is required when adjustments are desired.

Therefore, it is useful to provide a digital photo frame capable of adjusting brightness automatically.

### BRIEF DESCRIPTION OF THE DRAWINGS

The components in the drawing are not necessarily drawn to scale, the emphasis instead being placed upon clearly illustrating the principles of the digital photo frame.

The drawing is a block diagram of a digital photo frame in accordance with an exemplary embodiment.

### DETAILED DESCRIPTION

Referring to the drawing, a digital photo frame (DPF) 1 includes a processing unit 10, a power source 20, a light detector 30, a sound sensor 40, a power management unit 50, a display panel 60, a storage unit 70, a user input unit 80, and an interface unit 90 (e.g., an input port or wireless transceiver). The DPF 1 is capable of adjusting brightness automatically upon sensing someone around the DPF 1 within a predetermined area and the ambient light level being relatively dark.

The storage unit 70 is configured to store displayable media such as digital pictures. The display panel 60 is configured to display the displayable media stored in the storage unit 70. The user input unit 80 is configured to generate instructions in response to user operations. The user input unit 80 can be input keys/buttons, knobs, and the like. The interface unit 90 is configured to connect to an external electronic device (not shown). The external device can be a storage card (e.g., a secure digital SD card, a compact flash CF card) or another electronic device (e.g., a digital camera, a mobile phone, or a computer).

The storage unit 70 is further configured to store a table. The table includes a plurality of light level ranges and a plurality of preferred brightness values corresponding to the light level ranges relatively. The light level ranges represent various ranges of ambient light levels, for example, the ambient light level is quite dark, dark, normal, bright, quite bright and so on. For each light level range, there is one preferred brightness value accordingly. The table maybe pre-stored in the memory 70, or set by the user through the user input unit 80.

The power source 20 can be a battery or an AC/DC (alternating current to direct current) module. The power management unit 50 is configured to distribute power from the power source 20 to elements of the DPF 1, such as the processing unit 10, the sound sensor 40, the light detector 30, and the display panel 60.

The light detector 30 is configured to detect a current ambient light level and produce a light signal to the processing unit 10.

The sound sensor 40, connected to the processing unit 10, is configured for continuously detecting sound waves around the DPF 1, and sending a sound signal to the processing unit 10 according to the detected sound wave.

The processing unit 10 is configured to convert the sound signal into digital sound value, compare the digital sound value with a predetermined value stored in the memory 70. The processing unit 10 is configured to control the power management unit 50 to power on the light detector 30 when the digital sound value is larger than or equal to the predetermined value. The processing unit 10 is also configured to convert the light signal to digital light level value, look up the digital light level value in the table in the storage unit 70 to determine the light level range that the digital light level value is included in, obtain the preferred brightness value according to the determined light level range, and adjust the brightness of the display panel 60.

In another embodiment, the preferred brightness value can instead be a preferred brightness range. When the brightness range is obtained after the light level range is determined, the processing unit can change the brightness of the display panel 60 according to any value within the preferred brightness range.

It is believed that the present embodiments and their advantages will be understood from the foregoing description, and it will be apparent that various changes may be made thereto without departing from the spirit and scope of the disclosure or sacrificing all of its material advantages, the examples hereinbefore described merely being preferred or exemplary embodiments of the present disclosure.

What is claimed is:

1. A digital photo frame (DPF) for automatically adjusting brightness, comprising:
a power management unit connected to a power source, configured for distributing power from the power source to the DPF;
a display panel configured for displaying displayable media;
a sound sensor configured for detecting sound waves around the DPF and generating a sound signal according to the detected sound wave;
a light detector configured for detecting current ambient light level and producing a light signal corresponding to the detected ambient light level; and
a processing unit configured for adjusting brightness of the display panel according to the sound signal and the light signal.

2. The DPF of claim 1, wherein the processing unit is configured to convert the sound signal into digital sound value, compare the digital sound value with a predetermined value stored in a memory, and control the light detector to work when the digital sound value is larger than or equal to the predetermined value.

3. The DPF of claim 2, wherein the storage unit is configured for storing a plurality of light level ranges and a plurality of preferred brightness values corresponding to the light level ranges, the processing unit is further configured to convert the light signal to a digital light level value, compare the digital light level value with the light level ranges to determine one light level range that the digital light level value is included in, obtain the preferred brightness value according to the determined light level range, and adjust the brightness of the display panel according to the preferred brightness value.

4. The DPF of claim 2, wherein the storage unit is configured for storing a plurality of light level ranges and a plurality of preferred brightness ranges corresponding to the light level ranges, the processing unit is further configured to convert the light signal to a digital light level value, compare the digital light level value with the light level ranges to determine one light level range that the digital light level value is included in, obtain the preferred brightness range according to the determined light level range, and adjust the brightness of the display panel according to one value within the preferred brightness range.

5. A method of automatically adjusting brightness of a digital photo frame (DPF), the method comprising:
detecting sound waves around the DPF and generating a sound signal according to the detected sound wave;
detecting current ambient light level and producing a light signal corresponding to the detected ambient light level; and
adjusting brightness of a display panel of the DPF according to the sound signal and the light signal.

6. The method of claim 5, wherein the step of detecting current ambient light level and producing a light signal further comprises:
converting the sound signal into digital sound value;
comparing the digital sound value with a predetermined value stored in a memory; and
controlling the light detector to work when the digital sound value is larger than or equal to the predetermined value.

7. The method of claim 6, further comprising:
supplying the storage unit for storing media for displaying, a plurality of light level ranges and a plurality of preferred brightness values corresponding to the light level ranges;
converting the light signal to a digital light level value;
comparing the digital light level value with the light level ranges to determine one light level range that the digital light level value is included in;
obtaining the preferred brightness value according to the determined light level range; and
adjusting the brightness of the display panel according to the preferred brightness value.

8. The method of claim 7, further comprising:
supplying the storage unit for storing media for displaying, a plurality of light level ranges and a plurality of preferred brightness ranges corresponding to the light level ranges;
converting the light signal to a digital light level value;
comparing the digital light level value with the light level ranges to determine one light level range that the digital light level value is included in;
obtaining the preferred brightness range according to the determined light level range; and
adjusting the brightness of the display panel according to one value within the preferred brightness range.
